(19) United States
(12) Patent Application Publication
(10) Pub. No.: US 2004/0024611 A1
(43) Pub. Date: Feb. 5, 2004

(54) Card information linkage system and method

(75) Inventor: Kyoko Agui, Kawasaki-shi (JP)

Correspondence Address: YOUNG & THOMPSON, 745 SOUTH 23RD STREET 2ND FLOOR, ARLINGTON, VA, 22202

(73) Assignee: NEC INFRONTIA CORPORATION, KWASAKI-SHI (JP)

(21) Appl. No.: 10/620,700

(22) Filed: Jul. 17, 2003

(30) Foreign Application Priority Data
Jul. 31, 2002 (JP) 2002-223372

(51) Int. Cl. G06F 17/60

(52) U.S. Cl. 705/1; 705/14; 705/10

(57) ABSTRACT

A management server has a function for creating customers' personal Web pages and providing them on the Internet, and a personal information database contained in a Personal Web page for each customer. A card server (X) and a card server (Y) each have a database for purchase/settlement information and customer information for the customer concerned. A store's terminal (W) and a store's terminal (Y) are terminals for processing the purchase of products with card X and card Y, respectively. The purchase information with each card is transmitted from each store's terminal to each card server. The card server transmits customer's purchase history information with each card, and the management server posts the received purchase history information on the personal Web page for the customer. The customer browses his or her personal Web page on a customer's terminal (A).

### BACKGROUND OF THE INVENTION

1. Field of the Invention

The present invention relates to a card information linkage system for linking purchase records with various cards such as credit cards and point cards and product information together to provide the linked information on the Web.

2. Description of the Related Art

When a user buys goods using various kinds of credit cards or point cards, it is the conventional practice for each card issuer to send the user a purchase record with the credit card or point card so that the user will have to manage all purchase records on a card basis.

In contrast to this, Japanese patent publication No. 2002-41776 (JP-A-2002-41776) discloses a hosting service system for household account book information, which allows a user to leave the management of his or her household account book information to a server side to save the user's labor and time for the management.

Further, Japanese patent publication No. 09-293096 (JP-A-09-293096) discloses an automatic household account data management system for updating a household account book to reflect data on payments not by card, other data on all money spent and received, and the like.

However, since purchase records are sent for respective cards, even the aforementioned systems do not allow the user to grasp all point or purchase records with multiple cards in their entirety. In addition, since cannot process or modify a purchase record with each card, the user has to transcribe the purchase records separately together with cash purchase records, or input them on a computer.

Further, when shopping at a store, the user cannot check any data, such as home stock status and specifications of consumables that are necessary to buy, to cause the user to forget essential purchases, buy too much, buy a wrong item of goods, and postpone purchasing decisions.

It is therefore an object of the invention to provide a card information linkage system and method for providing purchase record management information, composed of a combination of purchase records with multiple cards and cash purchase records, and personal information, together with products-related information, in the Web page format.

### SUMMARY OF THE INVENTION

To solve the above-mentioned problems, the present invention comprises a stores' terminal for entering purchase information on products purchased by card, a card server for storing purchase history information on products purchased by card, and a management server for creating customers' personal Web pages and providing them on a network. The stores' terminal includes means for transmitting purchase information on products that each customer has purchased by card to the card server. The card server includes means for storing the purchase information on products in a database and transmitting the purchase history information on products to the management server. The management server includes means for receiving the purchase history information on products and posting the same on a personal Web page for the customer concerned.

The aforementioned configuration enables purchase records with multiple cards to be linked together and provided in the Web page format.

### BRIEF DESCRIPTION OF THE DRAWINGS

FIG. 1 is a block diagram showing a system configuration of the invention; and

FIG. 2 is a flowchart for explaining the operation of the invention.

### DESCRIPTION OF THE PREFERRED EMBODIMENTS

embodiments of the present invention will be described below with reference to the accompanying drawings.

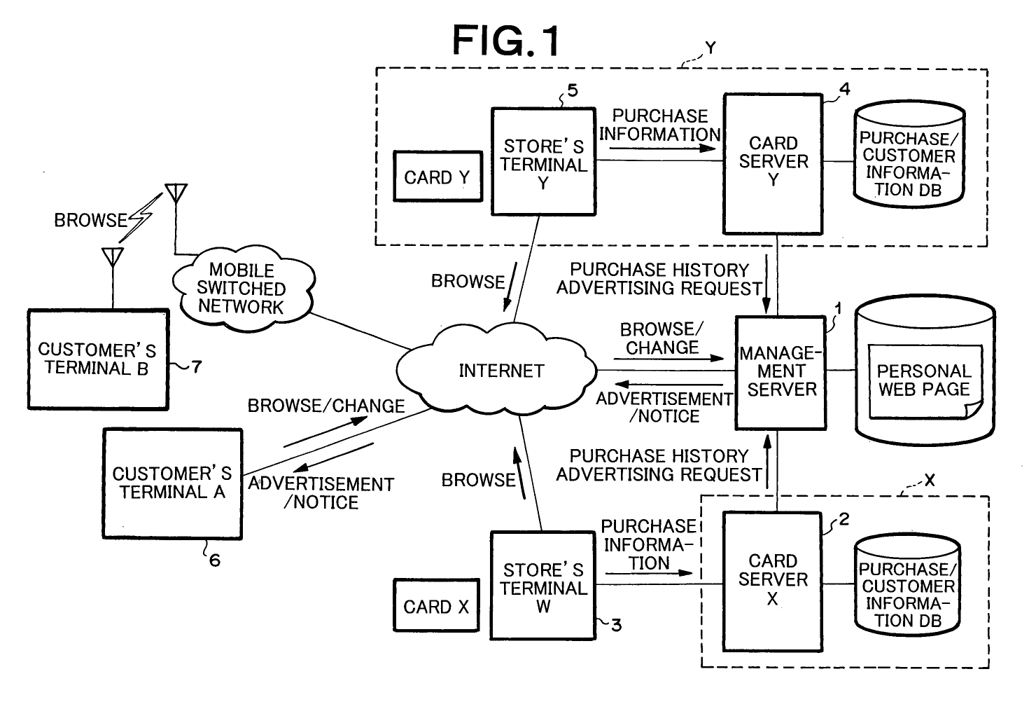

FIG. 1 is a diagram showing a system configuration of the invention. In the following description, a management server means a server system composed of multiple servers such as Web servers and mail servers, and a network means the Internet.

A management server 1 is placed in a management center. The management server 1 has a function for creating a personal Web page for each customer and providing it on the Internet, and a personal information database contained in the personal Web page. The personal information includes purchase records of each customer with each card (date of purchase, name of item, price, date of payment), other purchase records manually or bar-code inputted by the customer, card information (point and handling fee), customer's home inventory information (date of purchase, consumable period, number of pieces in stock, name of item in stock), tastes of the customer, and records of specifications (type and wattage of bulb, table size, etc.). The management server 1 also has a function for updating the personal Web page in response to a notice of addition and change of the personal information of the customer from each customer's terminal.

A card server (X) 2 is a card information management server at a credit card company issuing credit card X. The card server (X) 2 has a database and its management function. The database includes purchase/settlement information on the customer (date of purchase, purchased item (name and specifications of item), purchaser, price, retailer, payment account, payment method, date of payment), and customer information (name of card holder, attributes such as address, bank account, payment history). The card server (X) 2 is connected to the management server 1 via a dedicated line or the like. A store's terminal (W) 3 is a terminal placed at each store for processing purchases with the credit card X. The store's terminal (W) 3 is connected to the card server (X) 2 via a dedicated line or the like. The store's terminal (W) 3 has a function for performing authentication of the credit card X to confirm the identity of the customer, and accessing the management server 1 to display a personal Web page of the customer.

A card server (Y) 4 is a card information management server of retailer Y issuing point card Y. The card server (Y) 4 has a database and its management function. The database includes purchase/settlement information on the customer and customer information. The card server (Y) 4 is connected to the management server 1 via a dedicated line or the like. A store's terminal (Y) 5 is a terminal placed at each store for processing purchases with the point card Y. The store's terminal (Y) 5 is connected to the card server (Y) 4 via a dedicated line or the like. The store's terminal (Y) 5 has a function for performing authentication of the point card Y to confirm the identity of the customer, and accessing the management server 1 to display a personal Web page of the customer.

A customer's terminal (A) 6 is a browser-equipped personal computer or the like having a browsing function for accessing the Internet. When the customer's terminal is a facsimile machine, the customer can enter a predetermined number to output an image corresponding to the personal Web page provided by the management server 1. A customer's terminal (B) 7 is a customer-owned cellular phone or PDA with communication capabilities. The customer's terminal (B) 7 has a browsing function for accessing the Internet.

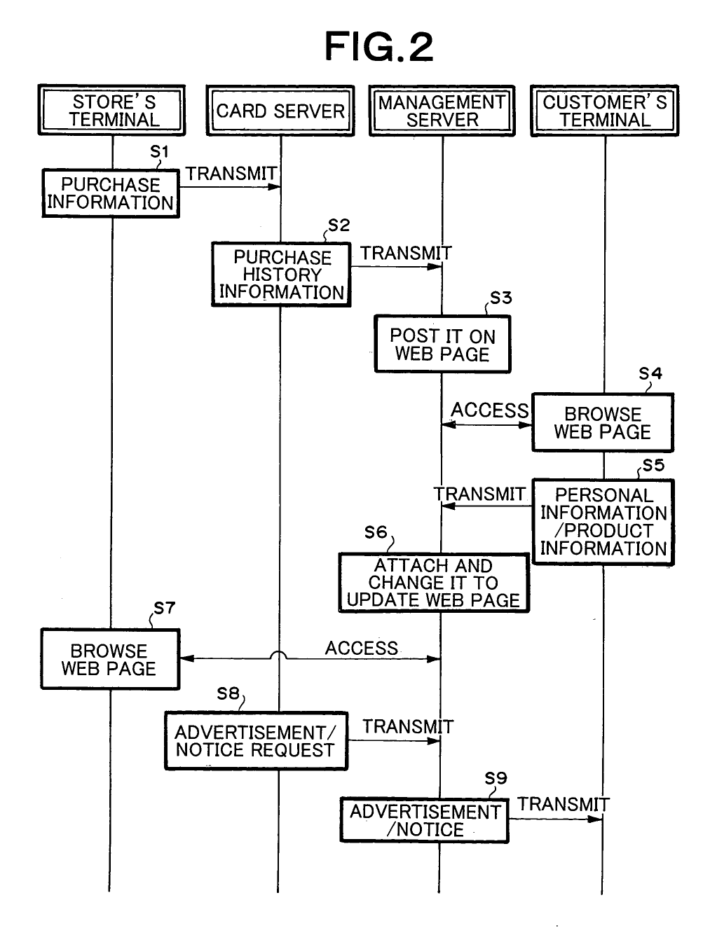

Referring next to FIG. 2, the operation of the system according to the invention will be described.

It is first assumed that a customer buys goods with the credit card X at the store W. The purchase information with the credit card X is transmitted from the store's terminal (W) 3 to the card server (X) 2 of the card company X (S1). Alternatively, the customer may buy goods at the store Y using the point card Y. The purchase information with the point card Y is transmitted from the store's terminal (Y) 5 to the card server (Y) 4 of the retailer Y (S1).

The card server (X) 2 or (Y) 4 receives the purchase information and stores it as purchase history information. Then it transmits to the management server 1 purchase history information on all products that the customer has purchased with the card up to this time (S2). The management server 1 posts the received purchase history information on the personal Web page for the customer (S3). It should be noted that when transmitting the purchase history information for the second or further time, the card server may transmit only a difference from the previous one, that is, only the purchase information on newly purchased products.

The customer can access the management server 1 from the customer's terminal (A) 6 through the Internet to browse his or her personal Web page (S4). In this case, the customer may enter his or her personal registration number and password to log in to a Web page addition/change mode so as to enter information on products purchased by payment methods other than by card, such as by cash, with a keyboard or barcode reader (S5). The customer can also enter any other information, such as the size of a cushion for buying its cover at each season, and check the button for requesting the distribution of products-related information to send the request. Further, the customer can enter a change of personal information such as change of address. The management server 1 receives these kinds of information to make additions and changes to the personal Web page for the customer (S6).

When shopping, the customer accesses the management server 1 from the customer's terminal (B) 7 through a mobile switched network and the Internet to browse his or her personal Web page (S7). Alternatively, the customer may access the management server 1 from the store's terminal (W) 3 or (Y) 5 to browse his or her personal Web page by performing authentication of the credit card X or the point card Y to confirm the identity of the customer (S7). Then the customer consults his or her purchase history or products-related information to buy necessary products. For example, if the customer happens to see something to his or her liking (e.g., a textile for curtains), he or she can consult his or her personal Web page to check the size of a bay window in his or her house listed on the page before buying it.

Next, the card server (X) 2 or (Y) 4 generates an appropriate product advertisement or products-related information from the purchase information or personal information for the customer, and transmits a distribution request to the management server 1 (S8). Here, the products-related information means product attribute information to be provided to the customer (such as manufacturer, vendor, raw material or ingredients, date of manufacture, consumable period, price, specifications (size, color, etc.), method of maintenance, and method of disposal).

In response to the distribution request, the management server 1 transmits an indication of “Out of Stock” or a notice of payment, or an advertisement or notice such as the “arrival of new products” suiting the tastes of each customer to the customer's e-mail address or via the fax number of the customer's terminal (A) 6 (S9). The customer reads the advertisement or the notice sent to the customer's terminal (A) 6, or the management server 1 posts the requested advertisement or notice on the personal Web page for the customer so that the customer can read it when browsing the page.

The customer makes an advance order and checks it at the store before buying it. The management server 1 takes the advance order and transfers the information to the card server (X) 2 or (Y) 4 so that the card server will manage of the advance order.

As described above, the present invention enables the collective management of purchase (payment) information with respective cards, access to information from multiple terminals, and a firm grasp of inventory information. It brings various advantages to consumers, such as to avoid forgetting to buy or buying too much, grasp price fluctuations and bottom prices, get detailed product information such as manufacturer, raw material or ingredients, and method of disposal, increase their awareness about quality, safety, and environments, and consult size or inventory information so that the consumers will not miss a buying chance.

It also brings advantages to retailers such as to provide information according to the tastes of each consumer so as to get repeaters.

It further brings advantages to card companies such as to facilitate the use of cards for shopping.

What is claimed is:

1. A card information linkage system, comprising:
a stores' terminal for entering purchase information on products purchased by card, a card server for storing purchase history information on products purchased by card, and a management server for creating customers' personal Web pages and providing them on a network, wherein
said stores' terminal includes means for transmitting purchase information on products that each customer has purchased by card to said card server,
said card server includes means for storing the purchase information on products in a database and transmitting the purchase history information on products to said management server, and
said management server includes means for receiving the purchase history information on products and posting the same on a personal Web page for the customer concerned.

2. The card information linkage system according to claim 1, further comprising:
a customers' terminal having a function for browsing Web pages through the network, wherein
said customers' terminal includes means for accessing said management server to display the personal Web page for the customer, and transmitting personal information on the customer or information on products purchased without any card and its related information, and
said management server includes means for attaching the received customer's personal information or purchased product information and its related information to update the personal Web page for the customer.

3. The card information linkage system according to claim 1, wherein
said card server further includes means for generating advertising of products purchased by the customer or products-related information, and transmitting it to said management server together with a distribution request, and
said management server further includes means for posting the received advertising of products or products-related information on the personal Web page for the customer, or transmitting it to a customer's e-mail address or fax number of said customer's terminal.

4. The card information linkage system according to claim 2, wherein
said card server further includes means for generating advertising of products purchased by the customer or products-related information, and transmitting it to said management server together with a distribution request, and
said management server further includes means for posting the received advertising of products or products-related information on the personal Web page for the customer, or transmitting it to a customer's e-mail address or fax number of said customer's terminal.

5. A card information linkage method for providing purchase records with multiple cards in the Web page format, comprising the steps of:
transmitting purchase information on products that each customer has purchased by card from a store's terminal for entering purchase information on products purchased by card to a card server for storing purchase history information on products purchased by card,
storing the purchase information on products in a database of said card server, and transmitting the purchase history information on products from said card server to a management server for creating customers' personal Web pages and providing them on a network, and
receiving the purchase history information on products at the management server, and posting the purchase history information on products on a personal Web page for the customer concerned.

6. The card information linkage method according to claim 5, comprising further the steps of:
accessing the management server to display the customer's personal Web page for the customer from a customer's terminal having a function for browsing Web pages through the network,
transmitting personal information on the customer or information on products purchased without any card and its related information from the customer's terminal to the management server, and
attaching the received customer's personal information or purchased product information and its related information to update the personal Web page for the customer at the management server.

7. The card information linkage method according to claim 5, comprising further the steps of:
generating advertising of products purchased by the customer or products-related information at the card server, and transmitting it to the management server together with a distribution request, and
posting the received advertising of products or products-related information on the personal Web page for the customer at the management server, or transmitting it to a customer's e-mail address or fax number of the customer's terminal.

8. The card information linkage method according to claim 6, comprising further the steps of:
generating advertising of products purchased by the customer or products-related information at the card server, and transmitting it to the management server together with a distribution request, and
posting the received advertising of products or products-related information on the personal Web page for the customer at the management server, or transmitting it to a customer's e-mail address or fax number of the customer's terminal.
